(19) United States
(12) Patent Application Publication
(10) Pub. No.: US 2002/0159346 A1
(43) Pub. Date: Oct. 31, 2002

(54) Optical disc device and method for controlling track hold thereof

(76) Inventor: Toshihiko Kaji, Niihama-shi (JP)

Correspondence Address: Parkhurst & Wendel, Suite 210, 1421 Prince Street, Alexandria, VA, 22314-2805, US

(21) Appl. No.: 09/914,229

(22) PCT Filed: Dec. 4, 2000
(86) PCT No.: PCT/JP00/08586

(30) Foreign Application Priority Data
Dec. 27, 1999 (JP) 11-368555

(51) Int. Cl. G11B 7/095

(52) U.S. Cl. 369/44.32; 369/53.14

(57) ABSTRACT

An optical disk device and a track hold control method thereof which can prevent runaway during tracking and carry out stable tracking even if the optical disk has a large eccentricity. An offset of a lens is monitored during track hold and kicking is effected at a timing at which the offset is the smallest when the lens passes over a track hold position, thus minimizing the offset upon tracking. Since there is no offset of the lens at the time of shifting to the tracking, a track hold processing is carried out stably.

### TECHNICAL FIELD

The present invention relates to an optical disk device for driving an optical disk such as a compact disk or a compact disk ROM and a track hold control method thereof.

### BACKGROUND ART

In recent years, an optical disk device has rapidly become a standard device mounted on a personal computer and has become essential as a function of the personal computer together with a hard disk. Most of the optical disk devices were originally compact disk (CD) ROM drives, while recently a DVD-ROM drive which has a higher capacity than the CD-ROM drive or a CD-R/CD-RW drive which is writable or rewritable has become a standard device mounted on the personal computer. Further, DVD-R and DVD-RAM drives have been marketed. Thus, there is no limit to enhancing performance and function of the optical disk device.

Such an optical disk device will be described below.

FIG. 1 is a block diagram showing a configuration of the optical disk device. In this optical disk device, a disk 11 is rotatably controlled at a constant linear speed or a constant angular speed by a spindle motor 12. A pickup 13 irradiates a laser beam to a recording surface of the rotating disk 11 while moving radially from an inner peripheral side to an outer peripheral side of the disk 11, and data on the recording surface of the disk 11 is read based on a change of a reflection of the laser beam.

A disk surface is spirally recorded with data called a pit, which is generally referred to as a track. In order to precisely read out the data on the track, the pickup 13 drives a lens 14 supported by wires within a housing of the pickup 13 perpendicularly to the disk surface to focus the laser beam on the disk surface.

Based on the change of the reflected laser beam from the disk surface, a deviation of the irradiated beam on the recording surface of the disk 11 relative to the center of the track is detected, and the lens 14 is radially horizontally driven with respect to the disk surface to carry out tracking control so that the laser beam is positioned at the center of the data on the track.

The lens 14 is driven by a driver IC 17 to control focusing on the disk 11 and a tracking servo, to read the data from the disk surface, and to send the data to an analog front end IC 18. The data is then transferred via a digital signal processor IC 19 and a decoder 21 to a host 22.

As described above, the data is spirally recorded, so that the lens 14 within the pickup 13 needs to move from the inner periphery to outer periphery of the disk as time elapses. Two kinds of methods are used for moving the tens 14. One is to move the lens 14 within the housing of the pickup 13, and the other is to move a feed 15, to which the pickup 13 is secured, by a feed motor 16, thereby to move the lens 14 together with the pickup 13.

Typically, such a method is used that the lens 14 is first moved to follow up the track, and at a point of time when the lens 14 is moved over a fixed position from the center of the housing, the feed 15 is moved by the feed motor 16 thereby to return the lens 14 to the center of the housing.

However, when the pickup 13 is moved from the inner periphery to the outer periphery in compliance with the data, the pickup 13 will deviate from the outermost periphery of the disk 11 eventually. Therefore, when the data is not being read, the pick up 13 is not moved and a current position thereof is held. This processing is called a track hold processing.

In the track hold processing, time information on a position desired to be held is set, and if the current position passes over a set hold position while tracing the data, kicking is effected for a few tracks toward the inner periphery.

In a conventional optical disk device as described above, as shown in FIG. 2, a lens 24 is supported by wires 25, 26 within a pickup 23. In reproducing a disk having a large eccentricity, for example, the lens 24 is driven, within the housing of the pickup 23, radially and horizontally with respect to the disk surface, and tracking control is carried out so that the laser beam is positioned directly above a center line 27 of the data which is periodically waved by the eccentricity of the disk as time elapses.

Variation in offset amounts of the lens 24 from the center in the pickup 23 at this time is shown in the FIG. 3.

In FIG. 3, a waveform 31 represents a property of a disk having a larger eccentricity than a waveform 32. When the track hold control is carried out for a disk having a large eccentricity, for example, there is a possibility of effecting the kicking at a point where the offset amount is increased as shown by an arrow 33, depending on the timing of effecting the kicking. Effecting the kicking when the lens 24 is largely offset within the pickup 23 sometimes causes unstable tracking control after the kicking.

Adverse effects given by the offset of the lens 42 on a servo control is then shown in FIG. 4. Typically, the lens 42 is positioned in the center of the pickup and refracts the beam from a laser 44 to be focused on a surface of a disk 41. The lens 42 has a function of returning the reflected beam from the disk 41 to a light receiving element 45.

However, if the lens is offset and positioned at a lens 43, the reflected beam from the laser 44 deviates from the light receiving element 45 as shown by dotted lines, and since a tracking servo generates a positional signal from the reflected beam of the disk 41, accurate data cannot be provided with such an offset lens so that the tracking servo is caused to be unstable. Thus, a problem has been posed.

The present invention has an object solve the above described conventional problem and to provide an optical disk device and a track hold control method thereof capable of preventing runaway during tracking control and carrying out stable tracking control even if the optical disk has a large eccentricity.

### DISCLOSURE OF INVENTION

In order to solve the above problem, an optical disk device and a track hold control method thereof according to the present invention are characterized in that an offset of a lens is monitored during track hold, and when the lens passes over a track hold position, kicking is effected at a timing the offset is minimized or at a predetermined timing just before the offset is minimized, so that the offset is minimized at the time of tracking control and the lens does not deviate at the time of shifting to the tracking control, thus executing a stable track hold processing.

Accordingly, runaway during the tracking control can be prevented even if the optical disk has a large eccentricity, so that the tracking control can be carried out stably.

An optical disk device according to claim 1 of the present invention comprises a control section for controlling track hold of a pickup with respect to an optical disk which is a recording medium, wherein in order to effect kicking in the track hold control, the control section operates to measure an offset amount of a lens relative to the center in the pickup, and effect the kicking when the measured offset amount is equal to or smaller than a predetermined value.

A track hold control method of an optical disk device according to claim 7 is a method for controlling, in an optical disk device, track hold of a pickup with respect to an optical disk which is a recording medium, wherein in order to effect kicking in a track hold processing, an offset amount of a lens relative to the center in the pickup is measured, and the kicking is effected only when the measured offset amount is equal to or smaller than a predetermined value.

According to these configuration and method, kicking is effected in an area where the offset of the lens is the smallest, so that the offset of the lens is small enough at the time of shifting to the tracking control, which permits a stable track hold processing.

The optical disk device according to claim 2 has the control section according to claim 1 which operates to change the predetermined value which is compared with the measured offset amount depending on the number of tracks for the kicking.

The track hold control method according to claim 8 is the method according to claim 7, wherein the predetermined value which is compared with the measured offset amount is changed depending on the number of tracks for the kicking.

These configuration and method permit a stable track hold processing without being influenced by the number of tracks for the kicking and there is only a small offset of the lens at the time of shifting to the tracking control.

An optical disk device according to claim 3 comprises a control section for controlling track hold of a pickup with respect to an optical disk which is a recording medium, wherein in order to carry out tracking after kicking is effected in the track hold, the control section operates to measure an offset amount of a lens relative to the center in the pickup, and carry out no tracking processing until the offset amount becomes equal to or smaller than a predetermined value.

A track hold control method according to claim 9 is a method for controlling, in an optical disk device, track hold of a pickup with respect to an optical disk which is a recording medium, wherein in order to carry out tracking after kicking is effected in the track hold processing, an offset amount of a lens relative to the center in the pickup is measured so that no tracking processing is carried out until the offset amount becomes equal to or smaller than a predetermined value.

According to these configuration and method, the tracking processing is carried out in an area where the offset of the lens is the smallest, which permits a stable track hold processing.

An optical disk device according to claim 4 comprises a control section for controlling track hold of a pickup with respect to an optical disk which is a recording medium, wherein in order to effect kicking in the track hold control, the control section operates to measure an offset amount of a lens relative to the center in the pickup several times, and effect the kicking when the offset amount is reduced each time of the measurements within a predetermined range.

A track hold control method for an optical disk device according to claim 10 is a method for controlling, in an optical disk device, track hold of a pickup with respect to an optical disk which is a recording medium, wherein in order to effect kicking in the track hold processing, an offset amount of a lens relative to the center in the pickup is measured several times, and the kicking is effected when the offset amount is reduced each time of the measurement within a predetermined range.

According to these configuration and method, the kicking is consequently effected just before an area where the offset of the lens the smallest, so that shifting to the tracking control occurs in the area where the offset of the lens is minimized, which permits a stable track hold processing.

The optical disk device according to claim 5 has the control section according to claim 4 operates to change the predetermined value which is compared with the offset amounts measured several times depending on the number of tracks for the kicking.

The track hold control method according to claim 11 is the method according to claim 10 wherein the predetermined value which is compared with the offset amounts measured several times is changed depending on the number of tracks for the kicking.

According to these configuration and method, the kicking is subject to no influence of the number of tracks, and shifting to the tracking control occurs in the area where the offset of the lens is minimized, which permits a stable track hold processing.

The optical disk device according to claim 6 is the device according to any one of claims 1 to 5, wherein the control section operates to store a measured maximum offset amount as an eccentricity amount of an optical disk in use.

The track hold control method for an optical disk device according to claim 12 is the method such that a measured maximum offset amount according to any one of claims 7 to 11 is stored to be regarded as an eccentricity amount of an optical disk in use.

These configuration and method permit selecting the number of rotation which is suitable for a disk, and thereby preventing read errors caused by mechanical resonance generated by rotating an eccentric disk at a high speed.

As described above, according to each of the above configurations and methods, an offset of a lens is monitored during track hold, and when the lens passes over a track hold position, kicking is effected at a timing at which the offset is minimized or at a predetermined timing just before the offset is minimized. Thus, the offset is minimized during tracking and it is possible to carry out a stable track hold processing with no offset of the lens at the time of shifting to the tracking control.

### BRIEF DESCRIPTION OF THE DRAWINGS

FIG. 1 is a block diagram showing a configuration of an optical disk device for carrying out a track hold control method according to Embodiments 1 and 2 of the present invention;

FIG. 2 is an explanatory view of a follow-up operation of a pickup lens according to Embodiments 1 and 2 of the present invention;

FIG. 3 is an explanatory view showing variation in offset amount of a lens during tracking control in a conventional optical disk device;

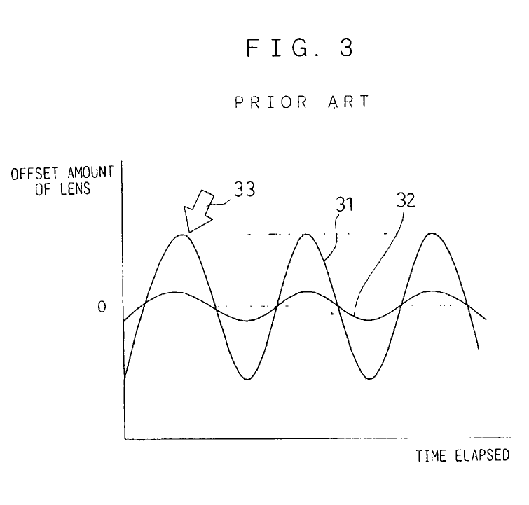

FIG. 4 is an explanatory view showing an effect on servo control made by the offset of the lens in the conventional example;

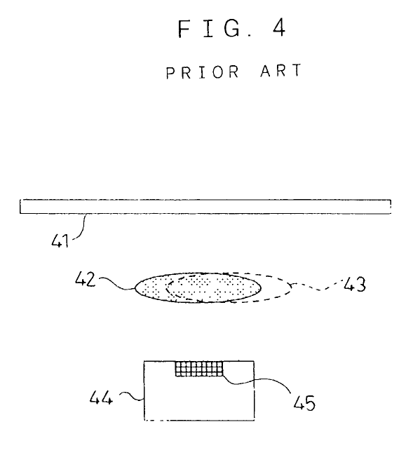

FIG. 5 is an explanatory view showing variation in offset amount of a lens during tracking control in the optical disk device for carrying out the track hold control method according to Embodiment 1 of the present invention;

FIG. 6 is an explanatory view showing a timing of kicking during the tracking control according to Embodiment 1 of the present invention;

FIG. 7 is an explanatory view showing variation in offset amount of a lens during tracking control in an optical disk device for carrying out a track hold control method according to Embodiment 2 of the present invention; and

FIG. 8 is an explanatory view showing a timing of kicking during the tracking control according to Embodiment 2 of the present invention.

### BEST MODE FOR CARRYING OUT THE INVENTION

An optical disk device and a track hold control method thereof representing embodiments of the present invention will be described below in detail with reference to the drawings.

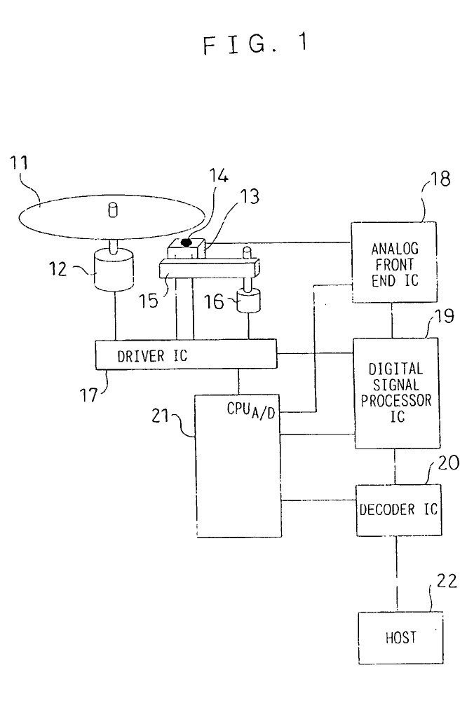

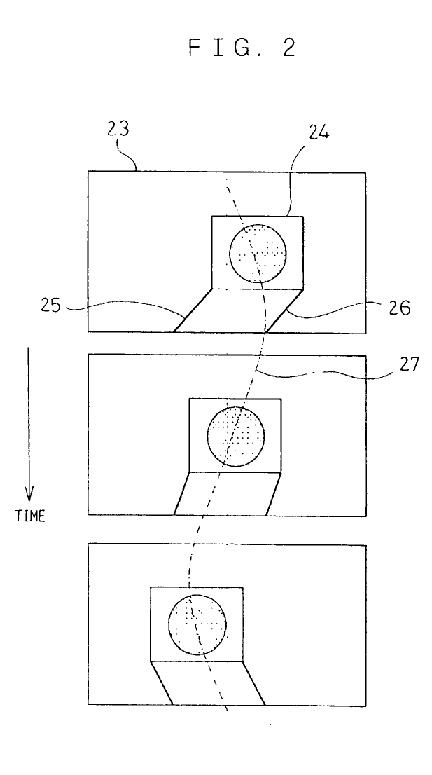

FIG. 1 is a block diagram showing a configuration of an optical disk device for carrying out a track hold control method according to the embodiments, and FIG. 2 is an explanatory view of follow-up operation of a pickup lens according to the embodiments.

### EMBODIMENT 1

An optical disk device and a track hold control method thereof according to Embodiment 1 of the present invention will be described.

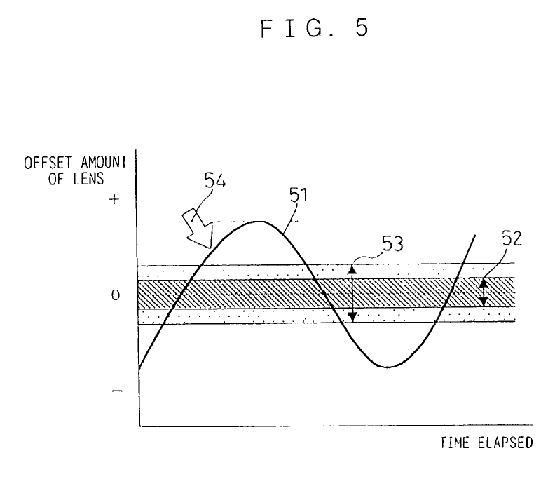

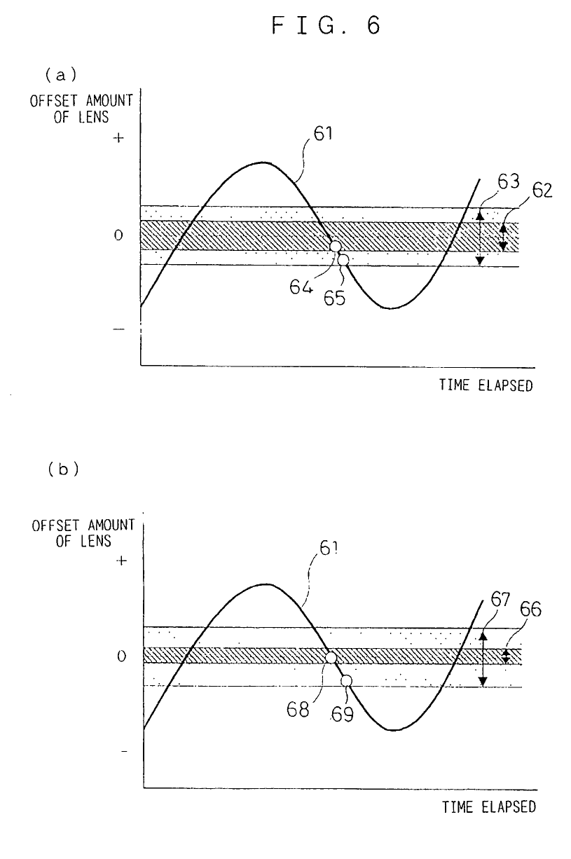

FIG. 5 is an explanatory view showing variation in offset amount of a lens during tracking control in an optical disk device for carrying out a track hold control method according to Embodiment 1, and FIG. 6 is an explanatory view showing a timing of kicking during the tracking control according to Embodiment 1.

First in FIG. 1, an offset amount of a lens 14 is input from a pickup 13 via an analog front end IC 18 into an A/D converter terminal of a CPU 21. The CPU 21 can, therefore, recognize the offset amount and an offset direction of the lens 14 by A/D converting with software thereof.

When tracking control is carried out using a disk 11 having a large eccentricity, as described above with reference to FIG. 2, the lens 24 is radially horizontally driven within a housing of a pickup 23 with respect to a disk surface and carries out the tracking control such that laser beam is positioned at the center of data, so that the variation in the offset amount of the lens 24 from the center in the pickup 23 is as shown by a waveform 51 in FIG. 5.

As a track hold processing here, the offset amount of the lens 24 from the center in the pickup 23 is monitored and when the amount of offset falls within an area 52, kicking is effected. Therefore, even if kicking is effected at the moment the lens passes over the area 52 at the worst timing, the offset amount of the lens falls within a range shown by an area 53 at the time of shifting to the tracking control, so that even the disk having a large eccentricity is shifted to undergo the tracking control in the area of a small offset to realize a stable tracking condition.

As another track hold processing, in light of the fact that length of time required for kicking depends upon the number of tracks for the kicking, even if the range of the area 52 is set smaller for the larger number of tracks for the kicking and the kicking is effected at the moment of passing over the area 52 at the worst timing, the offset amount of the lens 24 can fall within the range shown by an area 53 regardless of the number of tracks for the kicking at the time of shifting to the tracking control.

A detailed example is shown in FIG. 6. FIG. 6(a) shows a case of a small number of tracks for the kicking and an area 62 is set larger relative to the waveform 61, and when the kicking is effected at a point 64 which is an end of the area 62, the kicking is promptly finished because of the number of tracks being small and the shifting to the tracking control occurs at a point 65. The offset amount of the lens 24 at this time falls within an area 63.

On the other hand, FIG. 6(b) shows a case of the large number of tracks for the kicking, wherein an area 66 is set smaller than the area 62 relative to the waveform 61. When the kicking is effected at a point 68 which is an end of the area 66, the kicking takes time because of the number of tracks being large, and the shifting to the tracking control occurs at a point 69. However, the offset amount of the lens 24 at this time falls within an area 67 which is equal to the area 63, thereby allowing a stable tracking condition to be realized.

A kicking position is not limited, so that even if the kicking is effected in a position shown by an arrow 54 in the waveform 51, the shifting to the tracking control does not occur until the offset amount of the lens 24 falls within the area 53. Consequently, the same effect as described in the beginning of Embodiment 1 can be obtained.

### EMBODIMENT 2

An optical disk device and a track hold control method according to Embodiment 2 of the present invention will be described. The same configuration as in the above described Embodiment 1 will be represented using the same reference numerals and detailed description will be omitted here.

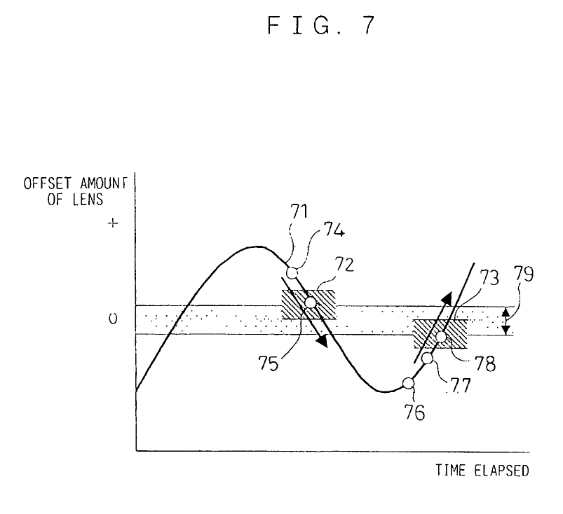

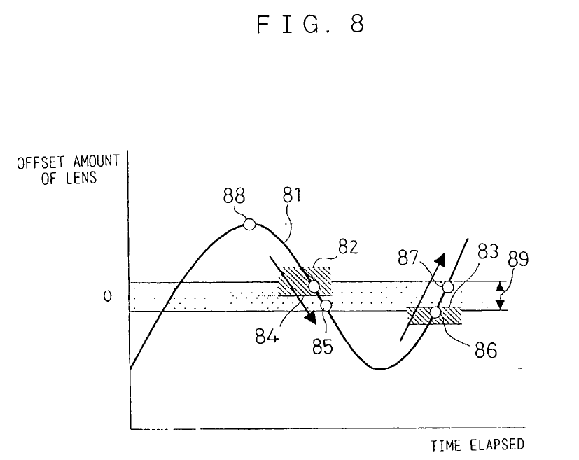

FIG. 7 is an explanatory view showing variation in offset amount of a lens during tracking control in an optical disk device for carrying out a track hold control method according to Embodiment 2, and FIG. 8 is an explanatory view showing a timing of kicking during the tracking control according to Embodiment 2.

As described in Embodiment 1, variation in offset amount of the lens 24 during the tracking control of a disk having a large eccentricity is as shown by a waveform 71 in FIG. 7. In a track hold processing here, the offset amount is measured twice at a fixed interval and, for example, a first offset amount 74 is compared with a second offset amount 75, and when the offset amount 75 is smaller than the offset amount 74 and the offset amount 75 falls within an area 72, kicking is effected. According to this, at the time of shifting to the tracking control, the offset amount of the lens falls within a range shown by an area 79.

In an another example, a first offset amount 76 is compared with a second offset amount 77, and when the offset amount 77 is smaller than the offset amount 76 but falls without an area 73, an offset amount 78 is measured again after a predetermined fixed interval. And, kicking is effected after the offset amount 78 has been confirmed to fall within the area 73. According to this, at the time of shifting to the tracking control, the offset amount of the lens falls within the range shown by the area 79.

As described above, even if the disk has a large eccentricity, the shifting to the tracking control occurs in an area with an especially small offset, which allows a greatly stable tracking condition to be realized.

In another track hold processing, in light of the fact that length of time required for kicking depends upon the number of tracks for the kicking, the ranges of the areas 72, 73 are set smaller as the number of tracks becomes larger, and even if the kicking is effected at a worst timing at the moment of passing over the areas 72, 73, the offset amount of the lens can fall within the range shown by the area 79 regardless of the number of tracks for the kicking at the time of shifting to the tracking control.

In a particular example shown in FIG. 8, when the number of tracks for the kicking is small, the area is set larger as an area 82, and when the kicking is effected at a point 84 which is an end of the area 82, the kicking is promptly finished because the number of tracks is small, and the shifting to the tracking control occurs at a point 85. The offset amount of the lens at this time falls within an area 89, which allows a stable tracking condition to be realized.

On the other hand, when the number of tracks for the kicking is large, the area is characteristically set to be smaller as an area 83, and when the kicking is effected at a point 86 which is an end of the area 83, the kicking takes time because the number of tracks is large and the shifting to the tracking control occurs at a point 87. However, the offset amount at this time also falls within the area 89, which allows a stable tracking condition to be realized.

Further, during the track hold processing, the offset amount of the lens is repeatedly measured to store a measured maximum offset amount 88, to allow an eccentricity amount of a disk in use to be obtained.

Thus, it is possible to limit the number of rotation of a disk having a large eccentricity, and therefore it is possible to prevent, in advance, occurrence of read errors caused by mechanical resonance generated by rotating an eccentric disk at a high speed.

1. An optical disk device comprising a control section for controlling track hold of a pickup with respect to an optical disk which is a recording medium, characterized in that
in order to effect kicking in the track hold control, the control section operates to measure an offset amount of a lens relative to the center in the pickup, and effect the kicking when the measured offset amount is equal to or smaller than a predetermined value.

2. The optical disk device according to claim 1, characterized in that the control section operates to change the predetermined value which is compared with the measured offset amount depending the number of tracks for the kicking.

3. An optical disk device comprising a control section for controlling track hold of a pickup with respect to an optical disk which is a recording medium, characterized in that
in order to carry out tracking after kicking is effected in the track hold, the control section operates to measure an offset amount of a lens relative to the center in the pickup, and carry out no tracking processing until the offset amount becomes equal to or smaller than a predetermined value.

4. An optical disk device comprising a control section for controlling track hold of a pickup with respect to an optical disk which is a recording medium, characterized in that
in order to effect kicking in the track hold control, the control section operates to measure an offset amount of a lens relative to the center in the pickup several times, and effect the kicking when the offset amount is reduced each time of the measurements within a predetermined range.

5. The optical disk device according to claim 4, characterized in that the control section operates to change the predetermined value which is compared with the offset amounts measured several times depending on the number of tracks for the kicking.

6. The optical disk device according to any one of claims 1 to 5, characterized in that the control section operates to store a measured maximum offset amount as an eccentricity amount of an optical disk in use.

7. A track hold control method for controlling, in an optical disk device, track hold of a pickup with respect to an optical disk which is a recording medium, characterized in that
in order to effect kicking in a track hold processing, an offset amount of a lens relative to the center in the pickup is measured, and the kicking is effected only when the measured offset amount is equal to or smaller than a predetermined value.

8. The track hold control method according to claim 7, characterized in that
the predetermined value which is compared with the measured offset amount is changed depending on the number of tracks for the kicking.

9. A track hold control method for controlling, in an optical disk device, track hold of a pickup with respect to an optical disk which is a recording medium, characterized in that
in order to carry out tracking after kicking is effected in the track hold processing, an offset amount of a lens relative to the center in the pickup is measured so that no tracking processing is carried out until the offset amount becomes equal to or smaller than a predetermined value.

10. A track hold control method for controlling, in an optical disk device, track hold of a pickup with respect to an optical disk which is a recording medium, characterized in that
in order to effect kicking in the track hold processing, an offset amount of a lens relative to the center in the pickup is measured several times, and the kicking is carried out when the offset amount is reduced each time of the measurement within a predetermined range.

11. The track hold control method according to claim 10, characterized in that the predetermined value which is compared with the offset amounts measured several times is changed depending on the number of tracks for the kicking.

12. The track hold control method according to any one of claims 7 to 11, characterized in that a measured maximum offset amount is stored as an eccentricity amount of the optical disk in use.
